(19) United States
(12) Patent Application Publication
(10) Pub. No.: US 2026/0118526 A1
(43) Pub. Date: Apr. 30, 2026

(54) OBSERVATION POINT DETERMINATION DEVICE AND OBSERVATION POINT DETERMINATION METHOD

(71) Applicant: JAPAN ATOMIC ENERGY AGENCY, Ibaraki (JP)

(72) Inventor: Masahiko MACHIDA, Kashiwa-shi, Chiba (JP)

(73) Assignee: JAPAN ATOMIC ENERGY AGENCY, Ibaraki (JP)

(21) Appl. No.: 18/860,789

(22) PCT Filed: Apr. 5, 2023
(86) PCT No.: PCT/JP2023/014074

§ 371 Date: Jun. 24, 2025

(30) Foreign Application Priority Data
May 20, 2022 (JP) 2022-083280

(51) Int. Cl. G01T 1/167; G21C 17/00

(52) U.S. Cl. CPC G01T 1/167; G21C 17/00

(57) ABSTRACT

To attempt optimization of observation points so as to surely observe an object to be observed while reducing the number of observation points as much as possible, the observation point determination device includes a minimum count determination unit that determines a minimum count of the observation points that will succeed in inversely estimating the object to be observed from an observation result at the observation point; a direct reach decision unit that decides whether a straight line connecting an arbitrary point of each grid face of a structure and a spatial grid point directly reaches this spatial grid point concerned; and an observation point determination unit that determines the observation point on the basis of the minimum count of the observation points and a decision result of the direct reach decision unit.

### TECHNICAL FIELD

The present invention relates to an observation point determination device and an observation point determination method that determine an observation point for observing an object to be observed in a target region.

### BACKGROUND ART

In the field of radiation measurement, when determining the position and number of measurement points, an empirical or legal standard or the like is often used to determine, to be the measurement point, a location that is likely to be contaminated by radioactive material. However, since it is difficult to evaluate the reasonableness of the measurement point determination, an excessive number of measurement points or an insufficient number of measurement points is usually set in the field of radiation measurement.

Such a difficulty in optimizing the measurement points is not limited to the radiation measurement, and may apply also to the installation of monitoring cameras, for example. As one of the techniques for attempting optimization of the installation points of the monitoring cameras, the technique disclosed in Patent Literature 1 is known, for example.

Patent Literature 1 discloses a technique related to an optimal arrangement search device that searches optimal arrangement conditions of a plurality of arrangement objects installed in a predetermined arrangement space. The technique disclosed in Patent Literature 1 comprises: an evaluation means that calculates an evaluation value for evaluating all arrangement conditions of the one or more arrangement objects installed in the arrangement space using range information representing a range of the arrangement space and arrangement information representing arrangement conditions of each of the plurality of arrangement objects installed in the arrangement space; a degree-of-contribution calculation means that calculates a degree of contribution of a target of interest according to an amount of change between an evaluation value calculated by the evaluation means when the plurality of arrangement objects, each set as the target of interest, is installed in the arrangement space and an evaluation value calculated by the evaluation means when remaining arrangement objects except for the target of interest are installed in the arrangement space; an update means that performs update processing for updating the arrangement conditions of each of the plurality of arrangement objects, the update processing including changing update of arrangement conditions of the arrangement object whose degree of contribution is a minimum value to be larger than update of arrangement conditions of the other arrangement objects; and an iterative determination means that outputs, as a search result of optimal arrangement conditions, the arrangement conditions of each of the plurality of arrangement objects represented by the arrangement information, the arrangement conditions being obtained by repeating calculation of the degree of contribution by the degree-of-contribution calculation means, update of the arrangement conditions by the update means, and calculation of the evaluation value by the evaluation means in order.

### CITATION LIST

### Patent Literature

Patent Literature 1: JP 2018-128961 A

### SUMMARY OF INVENTION

### Technical Problem

However, the technique disclosed in Patent Literature 1 is simply to search optimal arrangement conditions of a plurality of arrangement objects by changing update of arrangement conditions of the arrangement object whose degree of contribution is a minimum value to be larger than update of arrangement conditions of the other arrangement objects. That is, in the technique disclosed in Patent Literature 1, it is difficult to correct the number of arrangement objects itself to avoid an excessive number of arrangement objects or an insufficient number of arrangement objects.

In the field of radiation measurement, an excessive number of measurement points in a high-dose zone may not only require time and effort for measurement, but also cause an increase in radiation exposure dose, whereas an insufficient number of measurement points may impede estimation of a radiation source. This means that in the field of radiation measurement, it is desired that the number of measurement points be reduced as much as possible such that the radiation source can be inversely estimated from a radiation measurement result. This also applies to the case of attempting optimization of the installation points of monitoring cameras. That is, in terms of attempting optimization of observation points, such as the measurement points related to radiation measurement or the installation points of the monitoring cameras, the technique disclosed in Patent Literature 1 need be improved.

The present invention has been made in view of the foregoing, and provides an observation point determination device and an observation point determination method that can attempt optimization of the observation points so as to surely observe an object to be observed while reducing the number of observation points as much as possible.

### Solution to Problem

To solve the above issues, the observation point determination device of the present invention is an observation point determination device that determines an observation point for observing an object to be observed in a target region. The observation point determination device includes: a grid face generation unit that divides a surface of a structure in the target region and generates a plurality of grid faces; a spatial grid point generation unit that divides a space in the target region and generates a plurality of spatial grid points; a minimum count determination unit that determines a minimum count of the observation points that will succeed in inversely estimating the object to be observed from an observation result at the observation point, on the basis of a number of the objects to be observed and a number of the grid faces; a direct reach decision unit that decides, for each of the spatial grid points, whether a straight line connecting an arbitrary point of each grid face and the spatial grid point directly reaches the spatial grid point concerned; and an observation point determination unit that determines the observation point on the basis of the minimum count of the observation points and a decision result of the direct reach decision unit.

With this configuration, the observation point determination unit can determine the observation points so as to thoroughly observe the object to be observed in the target region while reducing the number of observation points as much as possible. Thus, the observation point determination device can attempt optimization of the observation points so as to surely observe the object to be observed while reducing the number of observation points as much as possible.

In a further preferred aspect, the observation point determination unit includes: a first determination unit that determines, to be the observation point, the spatial grid point which the straight lines from a largest number of the grid faces directly reach; and a second determination unit that specifies the grid face, the straight line from which does not directly reach the spatial grid point determined to be the observation point, and determines, to be the observation point, another spatial grid point which the straight line from the specified grid face directly reaches. The second determination unit continues determining the observation point until a number of the observation points determined by the first determination unit or the second determination unit reaches or exceeds the minimum count.

According to this aspect, the observation point determination unit can certainly ensure the minimum number of observation points required to succeed in inversely estimating the object to be observed from an observation result while reducing the number of observation points as much as possible. Accordingly, the observation point determination unit can determine the observation points so as to surely suppress impeding estimation of the object to be observed due to an insufficient number of observation points while reducing the number of observation points as much as possible. Thus, the observation point determination device can further attempt optimization of the observation points so as to surely observe the object to be observed while reducing the number of observation points as much as possible.

In a further preferred aspect, the second determination unit continues determining the observation point until the grid face, the straight line from which does not directly reach the spatial grid point determined to be the observation point, will no longer be found.

According to this aspect, the straight lines from all of the grid faces directly reach the observation points, and thus the observation point determination unit can determine the observation points so as to observe the object to be observed in the target region without a dead space. Accordingly, the observation point determination unit can determine the observation points so as to further thoroughly observe the object to be observed in the target region while reducing the number of observation points as much as possible. Thus, the observation point determination device can further attempt optimization of the observation points so as to surely observe the object to be observed while reducing the number of observation points as much as possible.

In a further preferred aspect, when the number of the objects to be observed is nₛ, the number of the grid faces is m, the minimum count is p, and a constant defined in advance according to a structure of the target region is α, the minimum count determination unit determines the minimum count using formula (1).

$$α {n}_{s} log ( m / {n}_{s} ) < p \qquad ( 1 )$$

According to this aspect, the minimum count determination unit can determine the minimum count p so as to certainly ensure the minimum number of observation points required to succeed in inversely estimating the object to be observed from an observation result. Thus, the observation point determination unit can determine the observation points so as to reduce the number of observation points as much as possible while certainly ensuring the minimum number of observation points required to succeed in inversely estimating the object to be observed from an observation result. As a result, the observation point determination device can further attempt optimization of the observation points so as to surely observe the object to be observed while reducing the number of observation points as much as possible.

In a further preferred aspect, the object to be observed is a radiation source present in the target region, the observation result is a measurement result of radiation radiated from the radiation source, and the observation point is a measurement point of the radiation.

According to this aspect, the observation point determination device can surely suppress requiring time and effort for measurement due to an excessive number of measurement points of radiation and causing an increase in radiation exposure dose. In addition, the observation point determination device can surely suppress impeding estimation of the radiation source due to an insufficient number of measurement points of radiation. Thus, the observation point determination device can attempt optimization of the measurement points of radiation so as to surely estimate the radiation source while reducing the number of measurement points of radiation as much as possible.

In a further preferred aspect, the object to be observed is an object to be monitored present in the target region, the observation result is an image captured by a monitoring camera that monitors the object to be monitored, and the observation point is an installation point of the monitoring camera.

According to this aspect, the observation point determination device can surely suppress requiring time and effort for installation due to an excessive number of monitoring cameras installed. In addition, the observation point determination device can surely suppress impeding monitoring of an object to be monitored due to an insufficient number of monitoring cameras installed, with a dead space in the target region. Thus, the observation point determination device can attempt optimization of the installation points of monitoring cameras so as to surely monitor an object to be monitored while reducing the number of monitoring cameras installed as much as possible.

In addition, the observation point determination method of the present invention is an observation point determination method that determines an observation point for observing an object to be observed in a target region. The observation point determination method includes: dividing a surface of a structure in the target region and generating a plurality of grid faces; dividing a space in the target region and generating a plurality of spatial grid points; determining a minimum count of the observation points that will succeed in inversely estimating the object to be observed from an observation result at the observation point, on the basis of a number of the objects to be observed and a number of the grid faces; deciding, for each of the spatial grid points, whether a straight line connecting an arbitrary point of each grid face and the spatial grid point directly reaches the spatial grid point concerned; and determining the observation point on the basis of the minimum count of the observation points and a decision result of whether the straight line directly reaches or not.

With this configuration, the observation point determination method can determine the observation points so as to thoroughly observe the object to be observed in the target region while reducing the number of observation points as much as possible. Thus, the observation point determination method can attempt optimization of the observation points so as to surely observe the object to be observed while reducing the number of observation points as much as possible.

### Advantageous Effects of Invention

According to the present invention, it is possible to provide an observation point determination device and an observation point determination method that can attempt optimization of the observation points so as to surely observe an object to be observed while reducing the number of observation points as much as possible.

### BRIEF DESCRIPTION OF DRAWINGS

FIG. 1 is a diagram illustrating a configuration of an observation point determination device of the present embodiment.

FIG. 2 illustrates a relationship among a radiation source vector, a radiation dose vector, and a matrix.

FIG. 3 is a view illustrating an example of a three-dimensional CG model of a target region.

FIG. 4 is a diagram illustrating grid faces generated by a grid face generation unit.

FIG. 5 is a diagram illustrating a process content in a direct reach decision unit.

FIG. 6 is a diagram illustrating a process content in an observation point determination unit.

FIG. 7 is a flowchart schematically illustrating a process performed by the observation point determination device.

FIG. 8 is a flowchart schematically illustrating a process performed subsequently to the process of FIG. 7.

### DESCRIPTION OF EMBODIMENTS

Hereinafter, an embodiment of the present invention will be described with reference to the drawings. Configurations denoted by the same reference numerals in each embodiment have the same functions in each embodiment unless otherwise specified, and description thereof will be omitted.

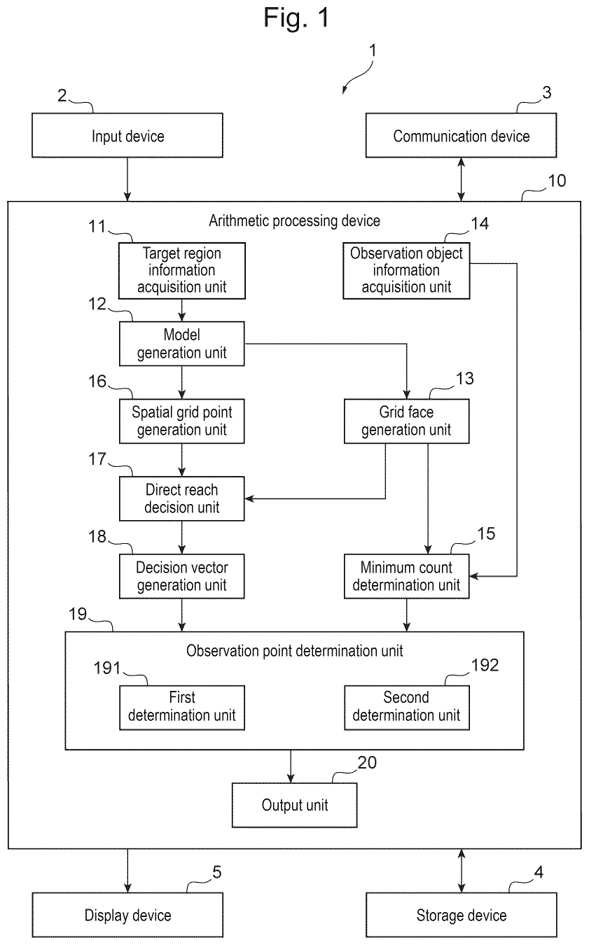

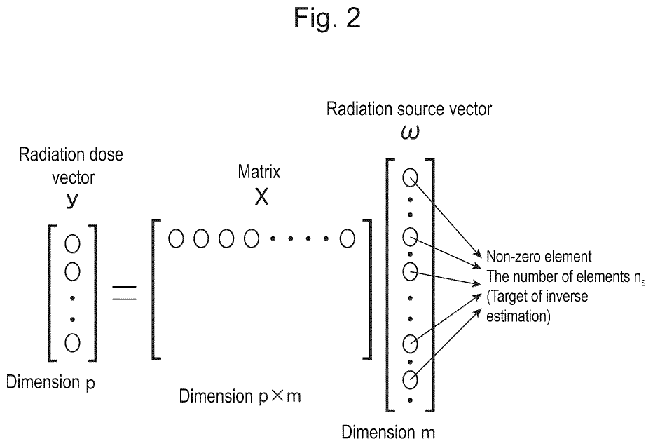

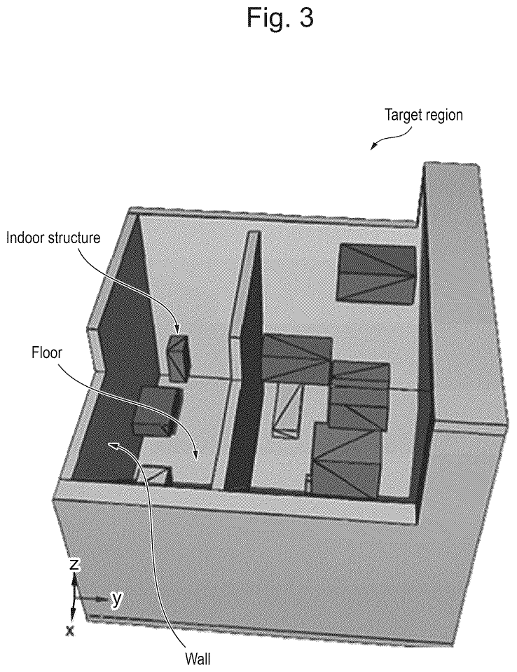

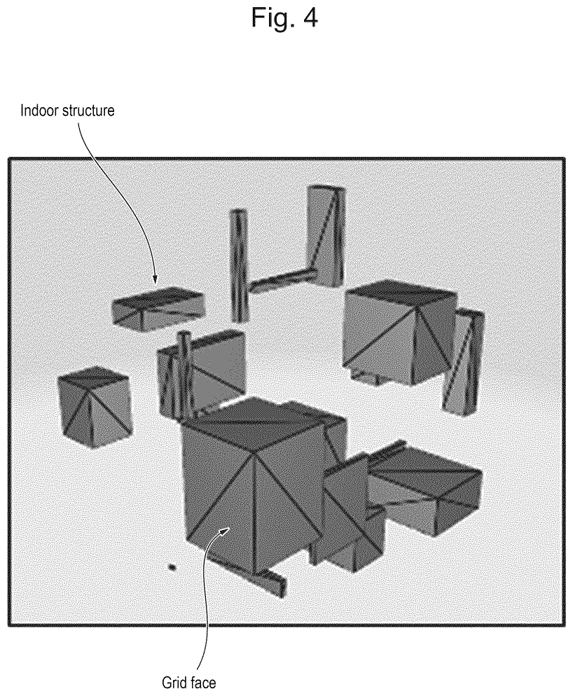

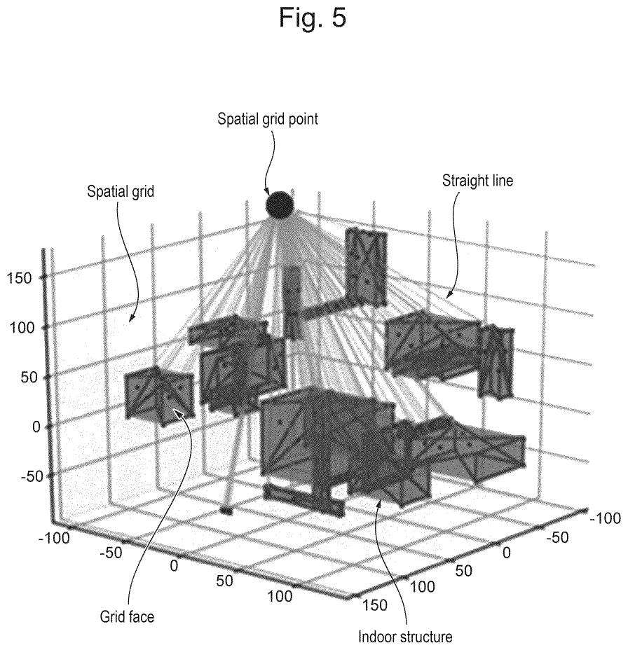

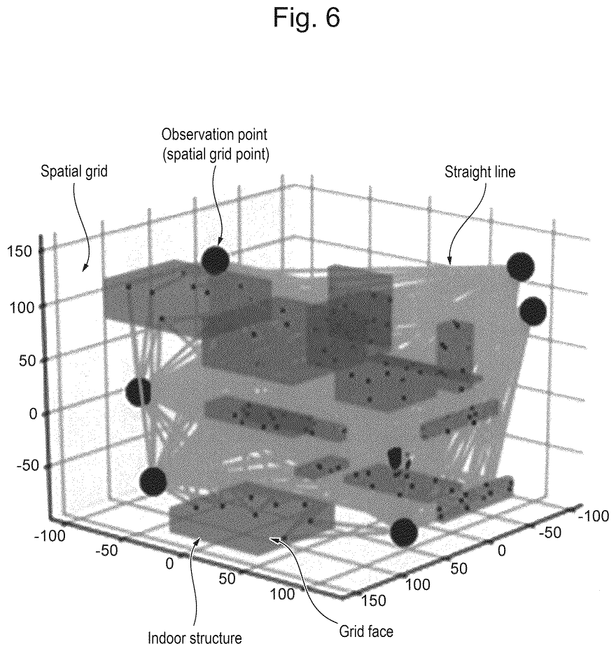

FIG. 1 is a diagram illustrating a configuration of an observation point determination device 1 of the present embodiment. FIG. 2 illustrates a relationship among a radiation source vector ω, a radiation dose vector y, and a matrix X. FIG. 3 is a view illustrating an example of a three-dimensional CG model of a target region. FIG. 4 is a diagram illustrating grid faces generated by a grid face generation unit 13. FIG. 5 is a diagram illustrating a process content in a direct reach decision unit 17. FIG. 6 is a diagram illustrating a process content in an observation point determination unit 19.

The observation point determination device 1 is a device incorporating a system that determines an observation point for observing an object to be observed in a target region. Determining an observation point means determining the position and number of observation points. The target region is a region for which an observation point is determined. The target region is, for example, a region contaminated by radioactive material, such as a nuclear power plant where a radioactive material leakage accident occurred and its surrounding area. In this case, the object to be observed is a radiation source present in the target region. The observation result is a measurement result of radiation radiated from the radiation source. The measurement result of radiation is, for example, a radiation dose such as a spatial dose rate or the like. The observation point is a measurement point of radiation.

In addition, the target region may be, for example, a monitoring region to be monitored by a monitoring camera or the like to suppress component theft and entry of a suspicious person, or the like. This monitoring region includes a general facility, as well as a region where radioactive material is stored. In this case, the object to be observed is an object to be monitored present in the target region such as an article containing radioactive material or a suspicious person and the like. The observation result is an image captured by the monitoring camera that monitors the object to be monitored. The observation point is an installation point of the monitoring camera.

In the following description of the present embodiment, by way of example, the target region is the interior of the building of the nuclear power plant having a complex structure, the object to be observed is a radiation source present in the target region, the observation result is a measurement result of radiation radiated from the radiation source, and the observation point is a measurement point of the radiation.

In the field of radiation measurement, an excessive number of measurement points in a high-dose zone may not only require time and effort for measurement, but also cause an increase in radiation exposure dose, whereas an insufficient number of measurement points may impede estimation of the radiation source. This means that in the field of radiation measurement, it is desired that the number of measurement points be reduced as much as possible such that the radiation source can be inversely estimated from a radiation measurement result. This inverse estimation may be implemented by the following method using sparse modeling.

That is, the inverse estimation method divides the target region into a plurality of subregions (also referred to as meshes, grids or elements) and generates a radiation source vector ω indicating a radiation source assumed to be present in the subregion. The radiation source vector ω is a column vector having an intensity of radiation radiated from the radiation source set in each subregion as the element value, and the number m of all set radiation sources as the number of elements. Furthermore, the inverse estimation method generates a radiation dose vector y indicating a measurement value obtained by measuring a radiation dose at a plurality of measurement points. The radiation dose vector y is a column vector having a measurement value at each of the measurement points as the element value, and the number of measurement points p as the number of elements. Furthermore, the inverse estimation method calculates a matrix X (also referred to as a contribution rate matrix X) indicating what degree of contribution to the measurement value, the radiation radiated to the measurement point from the radiation source indicated by the radiation source vector ω makes. The matrix X is a p×m matrix corresponding to the number of radiation sources m indicated by the radiation source vector ω and the number of measurement points p. Thus, in the inverse estimation method, as illustrated in FIG. 2, the radiation source vector ω, the matrix X, and the radiation dose vector y satisfy the relationship given by the following formula (2).

$$y = X ω \qquad ( 2 )$$

In the target region, high intensity radiation sources are present in a sparse manner in many cases. Thus, in the inverse estimation method, the radiation source vector ω is a sparse vector. Then, in the inverse estimation method, the radiation source vector ω is recovered using LASSO (Least Absolute Shrinkage and Selection Operator) for searching a radiation source vector ω that minimizes the objective function D given by the following formula (3).

$$D = \frac{1}{2 p} {‖ X ω - y ‖}_{2}^{2} + λ {‖ ω ‖}_{1} \qquad ( 3 )$$

Accordingly, the inverse estimation method can accurately estimate a distribution of the radiation sources in the target region from a small number of radiation measurement results. However, as described above, an insufficient number of measurement points may cause a failure of the inverse estimation, and may impede estimation of the radiation source. Then, the observation point determination device 1 determines a measurement point (observation point) of radiation so that the radiation source can be inversely estimated from a small number of radiation measurement results.

The observation point determination device 1 includes a so-called computer system. The observation point determination device 1 includes an input device 2, a communication device 3, a storage device 4, a display device 5, and an arithmetic processing device 10. The input device 2 includes a keyboard or a mouse and the like. The communication device 3 includes a communication device that communicates with an external device via a network. The storage device 4 includes an SSD or a HDD and the like. The storage device 4 stores various kinds of data used for the processing in the arithmetic processing device 10, and the like. The display device 5 includes various displays such as a liquid crystal display that displays a processing result and the like of the arithmetic processing device 10. The arithmetic processing device 10 includes a CPU, a ROM, a RAM, and the like. The arithmetic processing device 10 implements various functions of the observation point determination device 1 through execution of programs stored in the ROM by the CPU.

Note that the hardware configuration of the observation point determination device 1 is not particularly limited to the configuration illustrated in FIG. 1. Part of the functions of the arithmetic processing device 10 may be implemented through cooperative working with an external computer connected to the communication device 3 via a computer network.

The arithmetic processing device 10 includes a target region information acquisition unit 11, a model generation unit 12, a grid face generation unit 13, an observation object information acquisition unit 14, a minimum count determination unit 15, a spatial grid point generation unit 16, a direct reach decision unit 17, a decision vector generation unit 18, an observation point determination unit 19, and an output unit 20.

The target region information acquisition unit 11 acquires information about the structure of the target region (hereinafter also referred to as “target region information”). The target region information is, for example, point cloud data or polygon data of the target region. The target region information is generated in advance by performing 3D scanning or photogrammetry on the target region. The target region information acquisition unit 11 acquires the target region information from the input device 2 or the communication device 3.

Using the target region information acquired by the target region information acquisition unit 11, the model generation unit 12 generates a three-dimensional CG model (hereinafter also referred to as the “structural model”) representing structures in the target region, as illustrated in FIG. 3.

The grid face generation unit 13 divides the surface of the structure in the target region and generates a plurality of grid faces. Specifically, the grid face generation unit 13 divides the surfaces (the wall surface, the floor surface, the ground surface, the ceiling surface, and the surface of the indoor structure, or the like) of the interior of the building represented by the structural model generated by the model generation unit 12 and generates a plurality of grid faces. FIG. 4 illustrates an example in which one surface of the indoor structure is divided into a plurality of triangular grid faces. In the present embodiment, it is assumed that a radiation source is present on each grid face. The radiation source assumed to be present on each grid face corresponds to the radiation source indicated by the above-described radiation source vector ω. The grid face may be a candidate face of the radiation source.

The observation object information acquisition unit 14 acquires observation object information that is information about an object to be observed. The observation object information contains the number of objects to be observed. In the present embodiment, the number of objects to be observed corresponds to the number of high-intensity radiation sources present in the target region, and is set in advance by a user. The observation object information acquisition unit 14 acquires the observation object information from the input device 2 or the communication device 3.

The minimum count determination unit 15 determines the minimum count of the observation points that will succeed in inversely estimating the object to be observed from an observation result at the observation point, on the basis of the number of objects to be observed and the number of grid faces. Here, the number of objects to be observed contained in the observation object information acquired by the observation object information acquisition unit 14 is denoted by nₛ, the number of grid faces generated by the grid face generation unit 13 is denoted by m, and the minimum count of the observation points is denoted by p. The minimum count determination unit 15 determines the minimum count p using the following formula (1).

$$α {n}_{s} log ( m / {n}_{s} ) < p \qquad ( 1 )$$

In the above formula (1), α is the constant defined in advance according to the structure of the target region. α may be the value within the range from 2 to 4. In the present embodiment, α may be 3.83, for example. The formula (1), also referred to as the conditions of Candes-Tao, mathematically defines the minimum number of observation points required to succeed in inversely estimating the object to be observed from an observation result.

By determining the minimum count p using the above formula (1), the minimum count determination unit 15 can determine the minimum count p so as to certainly ensure the minimum number of observation points required to succeed in inversely estimating the object to be observed from an observation result. Thus, the observation point determination unit 19 can determine the observation points so as to reduce the number of observation points as much as possible while certainly ensuring the minimum number of observation points required to succeed in inversely estimating the object to be observed from an observation result. As a result, the observation point determination device 1 can further attempt optimization of the observation points so as to surely observe the object to be observed while reducing the number of observation points as much as possible.

The spatial grid point generation unit 16 divides the space in the target region and generates a plurality of spatial grid points. Specifically, the spatial grid point generation unit 16 divides the space in the target region represented by the structural model generated by the model generation unit 12 and generates a plurality of spatial grids. The spatial grid point generation unit 16 defines the intersection of the edges of adjacent spatial grids as the spatial grid point. The spatial grid and the grid face do not overlap each other. The spatial grid point may be a candidate point for the observation point.

The direct reach decision unit 17 decides, for each of the spatial grid points, whether a straight line connecting an arbitrary point of each grid face and the spatial grid point directly reaches the spatial grid point concerned. That is, the direct reach decision unit 17 decides, for each of the spatial grid points, whether the straight line connecting the arbitrary point of each grid face and the spatial grid point directly reaches the spatial grid point concerned, without passing through a grid face other than each of the grid faces concerned. For example, as illustrated in FIG. 5, the direct reach decision unit 17 focuses on one spatial grid point, and decides whether the straight line connecting the arbitrary point of one grid face and the spatial grid point concerned directly reaches the spatial grid point concerned. Next, the direct reach decision unit 17 decides whether the straight line connecting the arbitrary point of another grid face and the spatial grid point concerned directly reaches the spatial grid point concerned. Such decision is repeatedly performed and, for all of the grid faces, the direct reach decision unit 17 decides whether the straight lines connected to the spatial grid point concerned directly reach the spatial grid point concerned. After that, the direct reach decision unit 17 focuses on another spatial grid point, and decides whether the straight line connecting the arbitrary point of each grid face and the other spatial grid point focused directly reaches the other spatial grid point focused. Such decision is repeatedly performed and, for all of the spatial grid points, the direct reach decision unit 17 decides whether the straight line from each grid face directly reaches or not. Note that it is desired that the arbitrary point of each grid face be a center point of each grid face, but may be a point other than the center point as long as it is located within each grid face.

The decision vector generation unit 18 generates, for each of the spatial grid points, a decision vector indicating a decision result of the direct reach decision unit 17. That is, the decision vector generation unit 18 generates one decision vector with respect to one spatial grid point. For example, the decision vector generation unit 18 generates a column vector having an element value of 1 if the decision result of the direct reach decision unit 17 indicates that the straight line from one grid face directly reaches, or an element value of 0 if the decision result indicates that the straight line from another grid face does not directly reach, and the number of grid faces m as the number of elements. Then, the decision vector generation unit 18 generates decision vectors with respect to all of the spatial grid points.

The observation point determination unit 19 determines an observation point on the basis of the minimum count p of the observation points determined by the minimum count determination unit 15 and the decision result of the direct reach decision unit 17. Specifically, the observation point determination unit 19 determines an observation point on the basis of the minimum count p of the observation points determined by the minimum count determination unit 15 and the decision vectors generated by the decision vector generation unit 18. The observation point determination unit 19 includes a first determination unit 191 and a second determination unit 192.

The first determination unit 191 determines, to be the observation point, the spatial grid point which the straight lines from the largest number of the grid faces directly reach. Specifically, the first determination unit 191 selects, from the plurality of decision vectors generated by the decision vector generation unit 18, a decision vector having the largest number of elements with the element value 1, and determines the spatial grid point with the selected decision vector to be an observation point.

The second determination unit 192 specifies a grid face, the above-described straight line from which does not directly reach the spatial grid point determined to be the observation point, and determines, to be a next observation point, another spatial grid point which the above-described straight line from the specified grid face directly reaches. Specifically, the second determination unit 192 specifies an element with the element value 0 in the decision vector selected by the first determination unit 191, and with respect to the specified element, searches another decision vector having the largest number of elements with the element value 1. Then, the second determination unit 192 determines, to be a next observation point, the spatial grid point having the other decision vector found.

As illustrated in FIG. 6, the second determination unit 192 continues determining an observation point until the grid face, the above-described straight line from which does not directly reach the spatial grid point determined to be the observation point, will no longer be found. Specifically, until with respect to all of the elements with the element value 0 in the decision vector selected by the first determination unit 191, another decision vector having an element with the element value 1 is searched and the spatial grid point with the other decision vector searched is determined to be an observation point, the second determination unit 192 continues searching another decision vector and determining an observation point.

As a result, the straight lines from all of the grid faces directly reach the observation points, and thus the observation point determination unit 19 can determine the observation points so as to observe the object to be observed in the target region without a dead space. Accordingly, the observation point determination unit 19 can determine the observation points so as to further thoroughly observe the object to be observed in the target region while reducing the number of observation points as much as possible. Thus, the observation point determination device 1 can further attempt optimization of the observation points so as to surely observe the object to be observed while reducing the number of observation points as much as possible.

Furthermore, the second determination unit 192 continues determining an observation point until the number of observation points determined by the first determination unit 191 or the second determination unit 192 reaches or exceeds the minimum count p. Specifically, if the number of observation points determined is below the minimum count p, the second determination unit 192 specifies a decision vector of the spatial grid point that has already been determined to be the observation point in the order of determination of the observation point, and calculates a product of the specified decision vector and the decision vector of a spatial grid point that has yet been determined to be an observation point. Then, the second determination unit 192 selects the decision vector of the spatial grid point that has yet been determined to be an observation point, where the calculated product is the minimum, and determines the spatial grid point with the selected decision vector to be a next observation point. Then, the second determination unit 192 continues calculating the product and determining the observation point until the number of observation points reaches or exceeds the minimum count p.

As described above, the observation point determination unit 19 can certainly ensure the minimum number of observation points required to succeed in inversely estimating the object to be observed from an observation result while reducing the number of observation points as much as possible. Accordingly, the observation point determination unit 19 can determine the observation points so as to surely suppress impeding estimation of the object to be observed due to an insufficient number of observation points while reducing the number of observation points as much as possible. Thus, the observation point determination device 1 can further attempt optimization of the observation points so as to surely observe the object to be observed while reducing the number of observation points as much as possible.

The output unit 20 outputs information on the observation point determined by the observation point determination unit 19 to the display device 5 or the communication device 3. For example, the output unit 20 may superimpose the observation point determined by the observation point determination unit 19 on the structural model that is the three-dimensional CG model of the target region generated by the model generation unit 12, and generate a map that visualizes the distribution of the observation points in the target region. Further, the output unit 20 may display the generated map on the display device 5 or transmit it to the external device via the communication device 3 and display it on the external device.

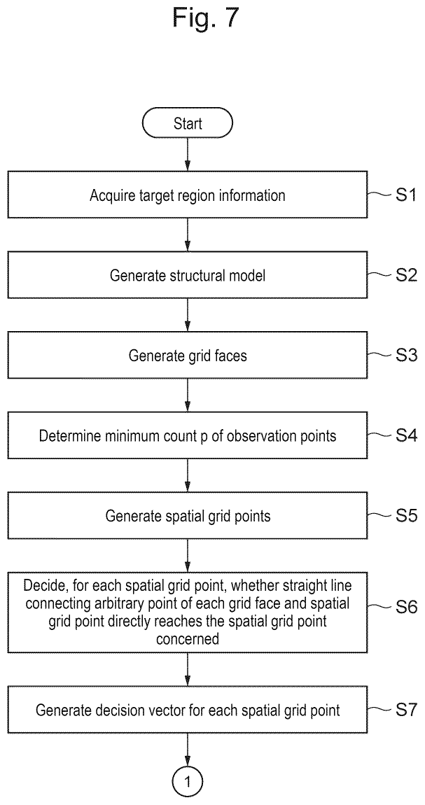

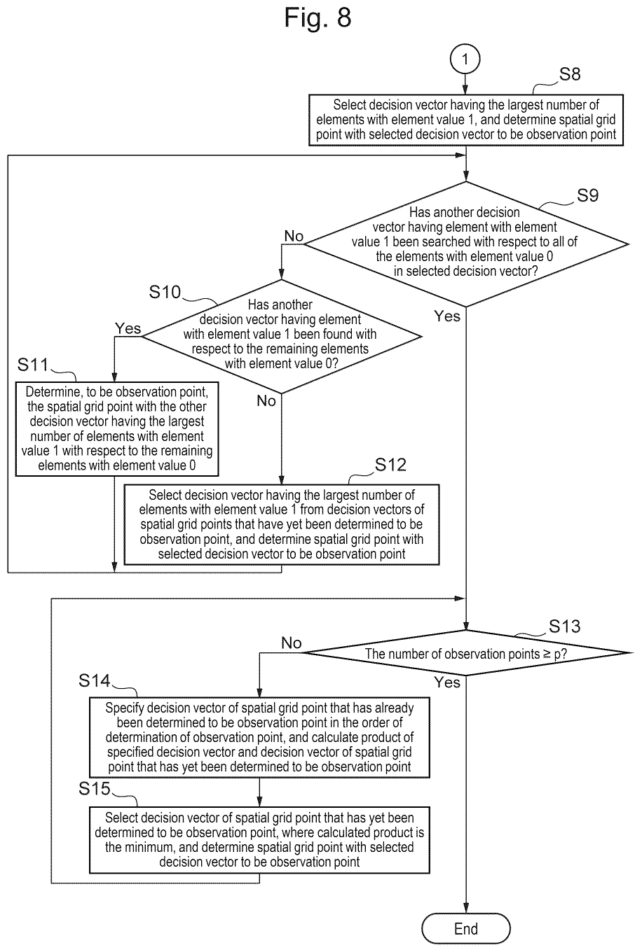

FIG. 7 is a flowchart schematically illustrating a process performed by the observation point determination device 1. FIG. 8 is a flowchart schematically illustrating a process performed subsequently to the process of FIG. 7.

In step S1, the observation point determination device 1 acquires target region information that is point cloud data of a target region or the like.

In step S2, the observation point determination device 1 generates a structural model of the target region using the acquired target region information.

In step S3, on the basis of the generated structural model, the observation point determination device 1 divides the surface of a structure in the target region and generates a plurality of grid faces.

In step S4, the observation point determination device 1 determines the minimum count p of the observation points using the above formula (1) on the basis of the number of generated grid faces m, the number of objects to be observed nₛ set in advance, and the constant α defined in advance.

In step S5, on the basis of the generated structural model, the observation point determination device 1 divides the space in the target region and generates a plurality of spatial grid points.

In step S6, the observation point determination device 1 decides, for each of the spatial grid points, whether a straight line connecting an arbitrary point of each grid face and the spatial grid point directly reaches the spatial grid point concerned.

In step S7, the observation point determination device 1 generates, for each of the spatial grid points, a decision vector indicating a decision result of whether the straight line from each grid face directly reaches or not.

In step S8, the observation point determination device 1 selects, from the plurality of decision vectors generated, a decision vector having the largest number of elements with the element value 1, and determines the spatial grid point with the selected decision vector to be an observation point.

In step S9, the observation point determination device 1 decides, with respect to all of the elements with the element value 0 in the selected decision vector, whether another decision vector having an element with the element value 1 has been searched. If the other decision vector concerned has been found with respect to all of the elements with the element value 0 in the selected decision vector, the observation point determination device 1 proceeds to step S13. If the other decision vector concerned has not been searched with respect to all of the elements with the element value 0 in the selected decision vector, the observation point determination device 1 proceeds to step S10.

In step S10, the observation point determination device 1 searches another decision vector having an element with the element value 1 with respect to the remaining elements with the element value 0 in the selected decision vector, and decides whether the other decision vector concerned has been found. If the other decision vector concerned has been found with respect to the remaining elements with the element value 0 in the selected decision vector, the observation point determination device 1 proceeds to step S11. If the other decision vector concerned has not been found with respect to the remaining elements with the element value 0 in the selected decision vector, the observation point determination device 1 proceeds to step S12.

In step S11, the observation point determination device 1 determines, to be the observation point, the spatial grid point with another decision vector having the largest number of elements with the element value 1 with respect to the remaining elements with the element value 0 in the selected decision vector. After that, the observation point determination device 1 proceeds to step S9.

In step S12, the observation point determination device 1 selects the decision vector having the largest number of elements with the element value 1 from the decision vectors of the spatial grid points that have yet been determined to be an observation point, and determines the spatial grid point with the selected decision vector to be an observation point. After that, the observation point determination device 1 proceeds to step S9.

In step S13, the observation point determination device 1 decides whether the number of observation points determined is equal to or larger than the minimum count p. If the number of observation points determined is equal to or larger than the minimum count p, the observation point determination device 1 ends the processes illustrated in FIG. 7 and FIG. 8. If the number of observation points determined is below the minimum count p, the observation point determination device 1 proceeds to step S14.

In step S14, the observation point determination device 1 specifies a decision vector of the spatial grid point that has already been determined to be the observation point in the order of determination of the observation point, and calculates a product of the specified decision vector and the decision vector of a spatial grid point that has yet been determined to be an observation point. The product to be calculated is an inner product.

In step S15, the observation point determination device 1 selects the decision vector of a spatial grid point that has yet been determined to be an observation point, where the calculated product is the minimum, and determines the spatial grid point with the selected decision vector to be an observation point. The spatial grid point that has yet been determined to be an observation point, where the calculated product is the minimum, is determined such that the number of straight lines, among those directly reach the spatial grid point concerned, that overlap the straight lines that directly reach the spatial grid points that have already been determined to be the observation points, is the minimum. Through the process in step S15, the observation point determination device 1 can newly determine an observation point having an observation range that does not overlap the observation ranges of the observation points that have already been determined as much as possible. Thus, the observation point determination device 1 can disperse the observation points so that the observation range of each observation point does not overlap the observation range of the other observation point, and uniformly distribute the observation points in the target region as much as possible. After step S15, the observation point determination device 1 proceeds to step S13.

As described above, the observation point determination device 1 of the present embodiment is an observation point determination device that determines an observation point for observing an object to be observed in a target region. The observation point determination device 1 includes the grid face generation unit 13 that divides a surface of a structure in the target region and generates a plurality of grid faces; and the spatial grid point generation unit 16 that divides a space in the target region and generates a plurality of spatial grid points. The observation point determination device 1 includes the minimum count determination unit 15 that determines the minimum count of the observation points that will succeed in inversely estimating the object to be observed from an observation result at the observation point, on the basis of the number of the objects to be observed and the number of the grid faces. The observation point determination device 1 includes the direct reach decision unit 17 that decides, for each of the spatial grid points, whether a straight line connecting an arbitrary point of each grid face and the spatial grid point directly reaches the spatial grid point concerned; and the observation point determination unit 19 that determines the observation point on the basis of the minimum count of the observation points and a decision result of the direct reach decision unit 17.

Accordingly, the observation point determination unit 19 can determine the observation points so as to thoroughly observe the object to be observed in the target region while reducing the number of observation points as much as possible. Thus, the observation point determination device 1 can attempt optimization of the observation points so as to surely observe the object to be observed while reducing the number of observation points as much as possible.

Furthermore, in the observation point determination device 1, the object to be observed is a radiation source present in the target region, the observation result is a measurement result of radiation radiated from the radiation source, and the observation point is a measurement point of radiation.

With this configuration, the observation point determination device 1 can surely suppress requiring time and effort for measurement due to an excessive number of measurement points of radiation and causing an increase in radiation exposure dose. In addition, the observation point determination device 1 can surely suppress impeding estimation of the radiation source due to an insufficient number of measurement points of radiation. Thus, the observation point determination device 1 can attempt optimization of the measurement points of radiation so as to surely estimate the radiation source while reducing the number of measurement points of radiation as much as possible.

Furthermore, in the observation point determination device 1, the object to be observed is an object to be monitored present in the target region, the observation result is an image captured by a monitoring camera that monitors the object to be monitored, and the observation point is an installation point of the monitoring camera.

With this configuration, the observation point determination device 1 can surely suppress requiring time and effort for installation due to an excessive number of monitoring cameras installed. In addition, the observation point determination device 1 can surely suppress impeding monitoring of an object to be monitored due to an insufficient number of monitoring cameras installed, with a dead space in the target region. Thus, the observation point determination device 1 can attempt optimization of the installation points of monitoring cameras so as to surely monitor an object to be monitored while reducing the number of monitoring cameras installed as much as possible.

The observation point determination method of the present embodiment may be achieved by the observation point determination device 1 performing the processes illustrated in FIG. 7 and FIG. 8.

That is, the observation point determination method of the present embodiment is an observation point determination method that determines an observation point for observing an object to be observed in a target region. The observation point determination method includes dividing a surface of a structure in the target region and generating a plurality of grid faces (step S3); and dividing a space in the target region and generating a plurality of spatial grid points (step S5). The observation point determination method includes determining the minimum count of the observation points that will succeed in inversely estimating the object to be observed from an observation result at the observation point, on the basis of the number of the objects to be observed and the number of the grid faces (step S4). The observation point determination method includes deciding, for each of the spatial grid points, whether a straight line connecting an arbitrary point of each grid face and the spatial grid point directly reaches the spatial grid point concerned (step S6); and determining the observation point on the basis of the minimum count of the observation points and a decision result of whether the straight line directly reaches or not (step S8 to step S15).

Accordingly, the observation point determination method of the present embodiment can determine the observation points so as to thoroughly observe the object to be observed in the target region while reducing the number of observation points as much as possible. Thus, the observation point determination method can attempt optimization of the observation points so as to surely observe the object to be observed while reducing the number of observation points as much as possible.

While the embodiment of the present invention is described above in detail, the present invention is not limited to the above-described embodiment, and various changes can be made without departing from the spirit of the present invention described in the claims. In the present invention, a configuration of one embodiment can be added to a configuration of another embodiment, a configuration of one embodiment can be replaced with a configuration of another embodiment, and a part of configurations of one embodiment can be deleted.

### REFERENCE SIGNS LIST

1 Observation point determination device
2 Input device
3 Communication device
4 Storage device
5 Display device
10 Arithmetic processing device
11 Target region information acquisition unit
12 Model generation unit
13 Grid face generation unit
14 Observation object information acquisition unit
15 Minimum count determination unit
16 Spatial grid point generation unit
17 Direct reach decision unit
18 Decision vector generation unit
19 Observation point determination unit
191 First determination unit
192 Second determination unit
20 Output unit

1. An observation point determination device that determines an observation point for observing an object to be observed in a target region, comprising:
a grid face generation unit that divides a surface of a structure in the target region and generates a plurality of grid faces;
a spatial grid point generation unit that divides a space in the target region and generates a plurality of spatial grid points;
a minimum count determination unit that determines a minimum count of the observation points that will succeed in inversely estimating the object to be observed from an observation result at the observation point, on the basis of a number of the objects to be observed and a number of the grid faces;
a direct reach decision unit that decides, for each of the spatial grid points, whether a straight line connecting an arbitrary point of each grid face and the spatial grid point directly reaches the spatial grid point concerned; and
an observation point determination unit that determines the observation point on the basis of the minimum count of the observation points and a decision result of the direct reach decision unit.

2. The observation point determination device according to claim 1,
wherein the observation point determination unit comprises:
a first determination unit that determines, to be the observation point, the spatial grid point which the straight lines from a largest number of the grid faces directly reach; and
a second determination unit that specifies the grid face, the straight line from which does not directly reach the spatial grid point determined to be the observation point, and determines, to be the observation point, another spatial grid point which the straight line from the specified grid face directly reaches, and
wherein the second determination unit continues determining the observation point until a number of the observation points determined by the first determination unit or the second determination unit reaches or exceeds the minimum count.

3. The observation point determination device according to claim 2, wherein the second determination unit continues determining the observation point until the grid face, the straight line from which does not directly reach the spatial grid point determined to be the observation point, will no longer be found.

4. The observation point determination device according to claim 1, wherein when the number of the objects to be observed is nₛ, the number of the grid faces is m, the minimum count is p, and a constant defined in advance according to a structure of the target region is α, the minimum count determination unit determines the minimum count using formula (1) given by
$$α {n}_{s} log ( m / {n}_{s} ) < p \qquad ( 1 )$$

5. The observation point determination device according to claim 1, wherein
the object to be observed is a radiation source present in the target region,
the observation result is a measurement result of radiation radiated from the radiation source, and
the observation point is a measurement point of the radiation.

6. The observation point determination device according to claim 1, wherein
the object to be observed is an object to be monitored present in the target region,
the observation result is an image captured by a monitoring camera that monitors the object to be monitored, and
the observation point is an installation point of the monitoring camera.

7. An observation point determination method that determines an observation point for observing an object to be observed in a target region, comprising:
dividing a surface of a structure in the target region and generating a plurality of grid faces;
dividing a space in the target region and generating a plurality of spatial grid points;
determining a minimum count of the observation points that will succeed in inversely estimating the object to be observed from an observation result at the observation point, on the basis of a number of the objects to be observed and a number of the grid faces;
deciding, for each of the spatial grid points, whether a straight line connecting an arbitrary point of each grid face and the spatial grid point directly reaches the spatial grid point concerned; and
determining the observation point on the basis of the minimum count of the observation points and a decision result of whether the straight line directly reaches or not.
